(19) United States
(12) Patent Application Publication
(10) Pub. No.: US 2012/0084844 A1
(43) Pub. Date: Apr. 5, 2012

(54) FEDERATION CREDENTIAL RESET

(76) Inventors: Jeremy Ray Brown, Orem, UT (US); Jason Allen Sabin, Lehi, UT (US); Nathaniel Brent Kranendonk, Springville, UT (US); Kal A. Larsen, Springville, UT (US); Lloyd Leon Burch, Payson, UT (US); Douglas Garry Earl, Orem, UT (US)

(21) Appl. No.: 12/895,047

(22) Filed: Sep. 30, 2010

(51) Int. Cl. G06F 21/00

(52) U.S. Cl. 726/6

(57) ABSTRACT

Techniques for federated credential reset are presented. A principal requests a credential reset with a first service. The first service provides a link to a third party service previously selected by the principal. The principal separately authenticates to the third party service and cause the third party service to send a federated token to the first service. When the federated token is received by the first service, the first service permits the principal to reset an original credential to a new credential for purposes of accessing the first service.

### BACKGROUND

The user validation technologies that most companies use today to reset passwords are very insecure and have problems with getting unique data that couldn't be acquired by searching the Internet using a user's name or other related information for the user.

Often times, a user can have his password reset by accessing a website's password reset facility. Once there, if the user knows his/her id, which often is not private and is publicly accessible to others, then the user is provided a series of challenge questions that permit the password at the website to be reset. A variety of problems are associated with this approach.

Firstly, the same challenge questions are often used from one site to another site; so, one site may know the answers to another site's challenge questions. Questions, such as: “Mother Maiden Name,” “Best Friends Name,” “City You Were Born in” are all examples of how one site could use the answers at their site to access another site with the same questions. Even though a particular site may offer multiple questions, the user is very likely to pick the one best known to them. This leads to a common or shared knowledge of the challenge questions and answers between sites because the challenge question can be used to change or set passwords, passwords are often no more secure than the challenge questions presented.

Secondly, when a site does not use standard or common challenge questions, then the user is likely to totally forget how he/she answered the questions. As a result, the user is locked out and needs to manually call someone or figure a way in which he/she can get valid access to his/her account because the automated mechanism is no longer available. In fact, if the wrong answer is provided three times or more, the user may be completely locked out of even trying to get the password reset in an automated manner.

### SUMMARY

Techniques for federated credential reset are presented. More particularly, and in an embodiment, a method for federated credential reset is described.

More particularly, a credential federation request is received from a principal; the principal causes the credential federation request to be generated by using a first service that the principal wants to authenticate with, but the principal is unable to provide an original credential required to authenticate to the first service. Next, the principal is authenticated for purposes of processing the credential federation request on behalf of the principal and a federated token is built. The federated token when presented to the first service authorizes the first service to reset the original credential of the principal. Finally, the federated token, which also identifies the principal, is passed back to the first service for the first service to reset the original credential on behalf of the principal.

### BRIEF DESCRIPTION OF THE DRAWINGS

FIG. 1 is a diagram of a method for federated credential reset, according to an example embodiment.

FIG. 2 is a diagram of another method for federated credential reset, according to an example embodiment.

FIG. 3 is a diagram of federated credential reset system, according to an example embodiment.

FIG. 4 is an example diagram of components and their interactions with one another for federated credential resetting, according to an example embodiment.

### DETAILED DESCRIPTION

A “resource” includes a user, service, system, device, directory, data store, groups of users, combinations of these things, etc. A “principal” is a specific type of resource, such as an automated service or user that acquires an identity. A designation as to what is a resource and what is a principal can change depending upon the context of any given network transaction. Thus, if one resource attempts to access another resource, the actor of the transaction may be viewed as a principal.

An “identity” is something that is formulated from one or more identifiers and secrets that provide a statement of roles and/or permissions that the identity has in relation to resources. An “identifier” is information, which may be private and permits an identity to be formed, and some portions of an identifier may be public information, such as a user identifier, name, etc. Some examples of identifiers include social security number (SSN), user identifier and password pair, account number, retina scan, fingerprint, face scan, etc.

Various embodiments of this invention can be implemented in existing network architectures. For example, in some embodiments, the techniques presented herein are implemented in whole or in part in the Novell® operating system products, directory-based products, cloud-computing-based products, and other products distributed by Novell®, Inc., of Waltham, Mass.

Also, the techniques presented herein are implemented in machines, such as processor or processor-enabled devices. These machines are configured and programmed to specifically perform the processing of the methods and systems presented herein. Moreover, the methods and systems are implemented, reside, and are programmed within a non-transitory computer-readable storage media or machine-readable storage medium and are processed on the machines configured to perform the methods.

Of course, the embodiments of the invention can be implemented in a variety of architectural platforms, devices, operating and server systems, and/or applications. Any particular architectural layout or implementation presented herein is provided for purposes of illustration and comprehension only and is not intended to limit aspects of the invention.

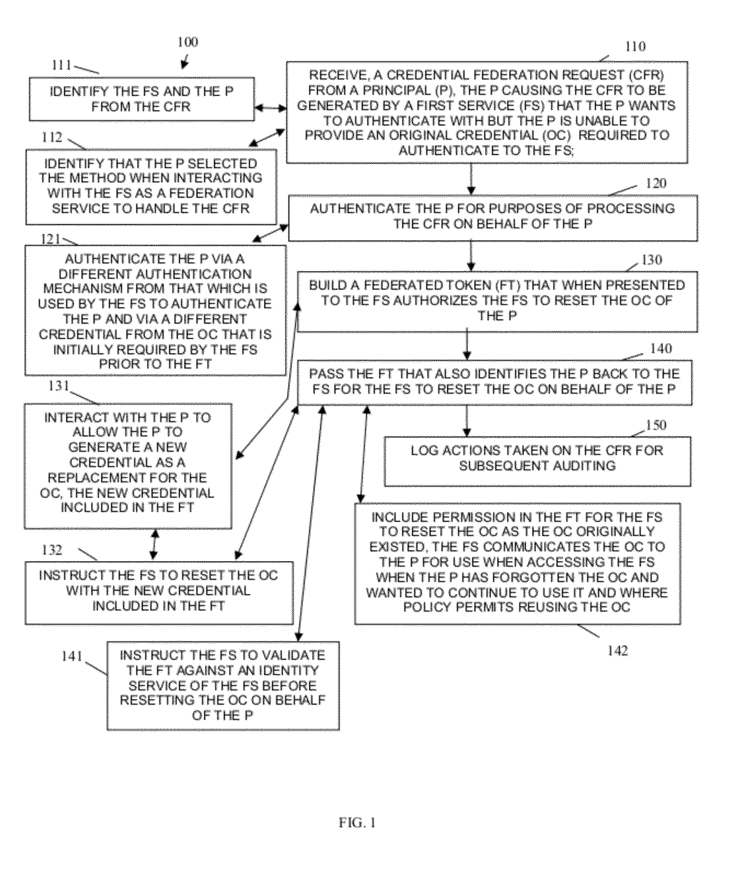

It is within this context that embodiments of the invention are now discussed within the context of FIGS. 1-4.

FIG. 1 is a diagram of a method 100 for federated credential reset, according to an example embodiment. The method 100 (hereinafter “federated token service”) is implemented in a machine-accessible and non-transitory computer-readable medium as instructions that execute on one or more processors and are programmed within the one or more processors (machines, computers, processors, etc.). The machines are specifically configured and programmed to process the federated token service. Furthermore, the federated token service is operational over and processes within a wide-area network (WAN). The WAN may be wired, wireless, or a combination of wired and wireless. In an embodiment, the WAN is the Internet.

At 110, the federated token service receives a credential federation request from a principal. The principal may be an end-user or an automated service capable of accessing services in an automated manner. The credential federation request is a request to have an original credential, which the principal needs to authenticate and access a first service, be reset by the first service. Conventionally, challenge and response questions and answers are internally used and managed by the first service or any website for purposes of resetting passwords (one form of a credential). The principal causes the credential federation request to be generated by the first service that the principal wants to authenticate with; however, the principal is unable to provide an original credential that is required to authenticate to the first service. This can occur because the principal has forgotten it or is in a position of using a device where the credential is unavailable to the principal.

According to an embodiment, at 111, the federated token service identifies the first service and the principal from the credential federation request. That is, the federated token service acquires unique identifiers or identities for both the first service and the principal from the credential federation request.

In another situation, at 112, the federated token service identifies that the principal selected the method when interacting with the first service as a federation service to handle the credential federation request. In other words, when the principal established an account with the first service, the principal selected the method as its preferred federation service to use when a credential reset was needed. It is noted that during that initial setup a variety of other federation services can be identified and potentially used as well by the principal in any given situation; however, here, the principal has identified and selected the method as the federation service to assist in resetting the principal's original credential with the first service.

At 120, the federated token service authenticates the principal for purposes of processing the credential federation request on behalf of the principal. So, the principal knows how to authenticate to the federated token service and that authentication is different from what is used with the first service. In fact, the principal likely selected the method as its federation service in the first instance because the principal knew that the principal had the credentials to authenticate to the federated token service.

According to an embodiment, at 121, the federated token service authenticates the principal via a different authentication mechanism from that which is used by the first service to authenticate the principal via a different credential from the original credential that is initially required by the first service prior to the federation token (discussed below at 130).

At 130, the federated token service builds a federated token that when presented to the first service authorizes the first service to reset the original credential of the principal to a new credential.

In an embodiment, at 131, the federated token service interacts with the principal to allow the principal to generate a new credential as a replacement credential for the original credential. The new credential can be included in this embodiment within the federated token.

Continuing with the embodiment of 131 and at 132, the federated token service instructs the first service to reset the original credential with the new credential that is included with the federated token.

At 140, the federated token service passes the federated token, which also identifies the principal, back to the first service for the first service to reset the original credential on behalf of the principal.

According to an embodiment, at 141, the federated token service instructs the first service to validate the federation token against an identity service of the first service before resetting the original credential on behalf of the principal.

In another case, at 142, the federated token service includes permission in the federation token for the first service to reset the original credential as the original credential originally existed. The first service communicates the original credential to the principal for use, when accessing the first service and when the principal has forgotten the original credential and wanted to continue to use the original credential and where policy permits reusing the original credential. In other words, the federation token can be used to just communicate the original credential to the principal so the reset is just sending the principal the needed original credential.

In an embodiment, at 150, the federated token service logs actions taken on the credential federation request for subsequent mining, auditing, reporting activities.

The credentials can be digital keys, certificates, or passwords.

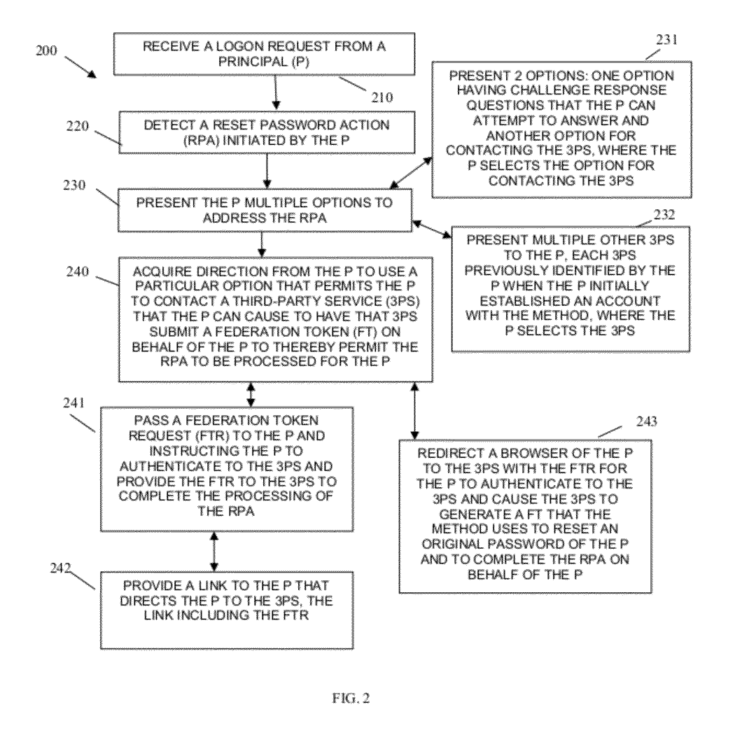

FIG. 2 is a diagram of another method 200 for federated credential reset, according to an example embodiment. The method 100 (hereinafter “principal's target service”) is implemented in a machine-accessible and non-transitory computer-readable medium as instructions that execute on one or more processors and are programmed on the one or more processors (machines, computers, processors, etc.). The machine is specifically configured and programmed to process the principal's target service. Furthermore, the principal's target service is operational over and processes within a network. The network may be wired, wireless, or a combination of wired and wireless. In an embodiment, the network is the Internet.

The federated token service represented by the method 100 of the FIG. 1 is presented from the perspective of a trusted third-party service known to the principal and the principal's target service. The principal's target service is presented from the perspective desired service that the principal wants to have a credential reset on to gain access to that desired service. The principal's target service interacts with the federated token service and the principal.

At 210, the principal's target service receives a logon request from a principal. The principal's target service may be viewed as the first service discussed above with reference to the method 100 of the FIG. 1. The principal wants to access the first service (resource, web site, etc.) over a network connection and for the principal to do so requires authentication. The principal in this scenario has either forgotten a password (one type of credential) needed for authentication or knows the password but wants to force a change of that password.

At 220, the principal's target service detects a reset password action initiated by the principal.

At 230, principal's target service presents the principal with multiple options to address the reset password action.

For example, at 231, the principal's target service may present two options to the principal. The first option includes using traditional challenge response questions that the principal can attempt to answer and the second option is for the principal to contact a third-party service. The principal selects the third-party service option.

In another scenario, at 232, the principal's target service presents multiple other third-party services to the principal, each third-party service was previously identified by the principal when the principal initially established an account with the method; again, the principal selects the third-party service from the list of other third-party services.

At 240, the principal's target service acquires direction from the principal to use a particular option that permits the principal to contact a third-party service that the principal can cause to have the third-party service submit a federation token on behalf of the principal to thereby permit the reset password action to be processed for the principal.

According to an embodiment, at 241, the principal's target service passes a federation token request to the principal and instructs the principal to authenticate to the third-party service and provide the federation token request to the third-party service to complete the processing of the reset password action.

Continuing with the embodiment of 241 and at 242, the principal's target service provides a link to the principal that directs the principal to the third-party service. The link includes the federation token request.

In still another situation, at 243, the principal's target service redirects a browser of the principal to the third-party service with the federation token request for the principal to authenticate to the third-party service and cause the third-party service to generate a federation token that the principal's target service (method) uses to reset an original password of the principal and to complete the reset password action on behalf of the principal.

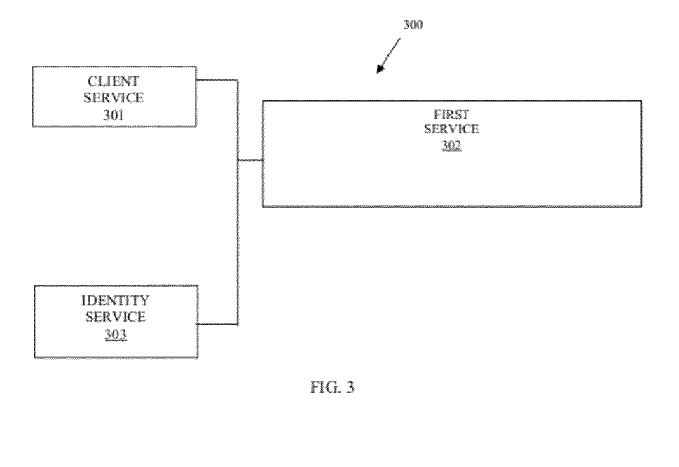

FIG. 3 is a diagram of federated credential reset system 300, according to an example embodiment. The federated credential reset system 300 is implemented on client and server devices that are programmed with instructions that reside in a machine-accessible and non-transitory computer-readable medium and that execute on multiple processors (machines, computers, processors, etc.) of the client and server devices. The machines are specifically configured and programmed to process the federated credential reset system 300. Furthermore, the federated credential reset system 300 is operational over and processes within a network. The network may be wired, wireless, or a combination of wired and wireless. In an embodiment, the network is the Internet.

In an embodiment, the federated credential reset system 300 implements, inter alia, the methods 100 and 200 of the FIGS. 1 and 2, respectively.

The federated credential reset system 300 includes a client service 301, a first service 302, and an identity service 303. Each of these components and their interactions with one another will now be described below in turn.

The client service 301 resides within and is programmed on a client and executes on one or more processors of the client. The client service 301 resides and is programmed in a non-transitory computer-readable storage medium. Example aspects of the client service 301 was provided above with respect to the actions of the principal discussed in the methods 100 and 200 of the FIGS. 1 and 2, respectively.

In an embodiment, the client service 301 is a browser that processes on the client and is interacted with by a principal. The principal uses the browser in an attempt to log into the first service 302 over a network connection via a first server having the first service 302 when the principal attempts to reset an original credential used to authenticate with the first service.

The principal separately authenticates to the identity service 303 via the second server of the identity service 303 and causes the identity service 303 to communicate a federated token to the first service 302 via the first server of the first service 302. The first service 302 then permits the principal to change to a new authentication credential for authenticating and accessing the first service 302.

The first service 302 resides within and is programmed on a first server and executes on one or more processors of the first server. The first service 302 resides and is programmed in a non-transitory computer-readable storage medium. Example aspects of the first service 301 were presented in detail above with reference to the method 200 of the FIG. 2.

According to an embodiment, the first service 302 is to present different identity services for the principal to use and the principal selects the identity service 303.

In another scenario, the first service 302 requests that the principal create a different authentication credential once the principal is authenticated with the new authentication credential for access. The different authentication credential used on subsequent logins made by the principal to the first service 302.

The identity service 303 resides within and is programmed on a second server and executes on one or more processors of the second server. The identity service 303 resides and is programmed in a non-transitory computer-readable storage medium. Example aspects of the identity service 303 were presented in detail above with reference to the method 100 of the FIG. 1.

According to an embodiment, the federated token includes the new authentication credential that the principal wants to use when the first service 302 receives the federated token and when the principal re-logs into the first service 302 and presents the new authentication credential, the principal is granted access to the first service 302.

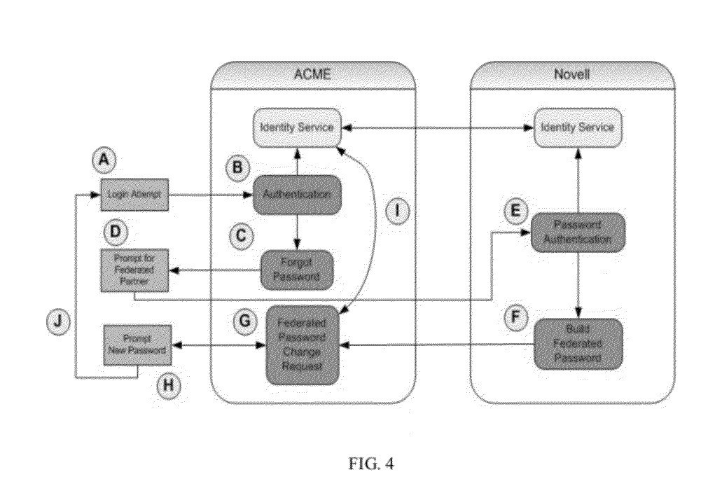

FIG. 4 is an example diagram of components and their interactions with one another for federated credential resetting, according to an example embodiment. It is noted that the architecture shown in the FIG. 4 is presented for purposes of illustration only as other components or less components can be used to realize the teachings presented herein. Therefore, the specific illustration of the FIG. 4 is not intended to limit the teachings in any manner.

Embodiments taught and discussed herein above and below take a different view on the password reset process than what has been conventionally achieved so one can validate without the challenge questions. A principal (user, automated service, etc.) can use trusted accounts with partners (third-party services, such as identity services and the like) to reset the principal's account and this provides a more secure technique than what has been available commercially. The federation token supplied from a trusted third-party service replaces the use of challenge questions for the user and provides a unique process. This avoids each site having a list of challenge response questions and answers. Although, the sites can maintain these challenge response questions and answers as alternatives if they so desire. The techniques used herein utilize federation tokens to reset passwords in place of challenge response questions.

When a user sets up an account at a site (first service as discussed above), the user may select another site (third-party service or identity service) to provide a federation token to use in case the password is lost or forgotten. Later, if the user forgets his/her password he/she can be sent to the site they selected to get a federation token. This token is used to allow a password change to the account at the first service or site.

These techniques allow companies to provide “password reset” as a service. This service can be used by many companies that wish to not manage passwords. It allows a single high level of assurance device, like a smart card to be used to reset passwords for many sites. This prevents cross site knowledge transfer.

The solution works with standard authentication schemes leveraged and enhanced as discussed herein. The techniques also improve upon the conventional password validation, which often utilizes an external email account to communicate a new password that is reset because herein reset can occur without having to send any email that is potentially exposed over the network wire to eavesdroppers.

Now referring to the FIG. 4 and its processing and components.

A is the first step where the login attempt is made by a principal/user.

B is where the user realizes that he/she doesn't know his/her password and he/she initiates further processing during the authentication process.

At C, the user clicks a forgot-password link. The system looks up the federation partner (third-party service) for this user, it could be the same or a different federation partner for each user; this can be set by policy.

At D, the user is prompted for the options to use an external service as a federation to complete the process. There may be more than one to choose from. In this example the second organization is Novell. But, this could easily be Google, Yahoo, Verisign, Facebook or any group that can federate and where the user already has credentials. Once the user has chosen the partner, then the process builds the federation request for the selected partner.

At E, once the federation request is built then the user authenticates against the partner; this can be done with whatever authentication is required to fulfill a predefined policy. An identity service is used in order to perform this functionality between the two organizations with ACME and Novell, as shown in the FIG. 4.

At F, once the authentication at Novell has been completed at E, then a token is built to authorize the request to change the password. The request is completed and passed back to G to make the change. The token defines the user and may include other information, such as a new password to be used at the ACME site.

At G, the password change request is verified against the identity service (at I) and once this verification is completed, then it can pass back to the user.

At H, the user may be prompted for a new password, which the user completes.

At J, the login attempt can be completed against the identity service for the authentication with the new password.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method implemented in a non-transitory machine-readable storage medium and processed by one or more processors configured to perform the method, comprising:
receiving, a credential federation request from a principal, the principal causing the credential federation request to be generated by a first service that the principal wants to authenticate with but the principal is unable to provide an original credential required to authenticate to the first service;
authenticating the principal for purposes of processing the credential federation request on behalf of the principal;
building a federated token that when presented to the first service authorizes the first service to reset the original credential of the principal; and
passing the federated token that also identifies the principal back to the first service for the first service to reset the original credential on behalf of the principal.

2. The method of claim 1, wherein receiving further includes identifying the first service and the principal from the credential federation request.

3. The method of claim 1, wherein receiving further includes identifying that the principal selected the method when interacting with the first service as a federation service to handle the credential federation request.

4. The method of claim 1, wherein authenticating further includes authenticating the principal via a different authentication mechanism from that which is used by the first service to authenticate the principal and via a different credential from the original credential that is initially required by the first service prior to the federation token.

5. The method of claim 1, wherein building further includes interacting with the principal to allow the principal to generate a new credential as a replacement for the original credential, the new credential included in the federated token.

6. The method of claim 5, wherein passing further includes instructing the first service to reset the original credential with the new credential included in the federated token.

7. The method of claim 1, wherein passing further includes instructing the first service to validate the federated token against an identity service of the first service before resetting the original credential on behalf of the principal.

8. The method of claim 1, wherein passing further includes including permission in the federated token for the first service to reset the original credential as the original credential originally existed, the first service communicates the original credential to the principal for use when accessing the first service when the principal has forgotten the original credential and wanted to continue to use it and where policy permits reusing the original credential.

9. The method of claim 1 further comprising, logging actions taken on the credential federation request for subsequent auditing.

10. A method implemented in a non-transitory machine-readable storage medium and processed by one or more processors configured to perform the method, comprising:
receiving a logon request from a principal;
detecting a reset password action initiated by the principal;
presenting the principal multiple options to address the reset password action; and
acquiring direction from the principal to use a particular option that permits the principal to contact a third-party service that the principal can cause to have that third-party service submit a federation token on behalf of the principal to thereby permit the reset password action to be processed for the principal.

11. The method of claim 10, wherein presenting further includes presenting two options: one option having challenge response questions that the principal can attempt to answer and another option for contacting the third-party service, where the principal selects the option for contacting the third-party service.

12. The method of claim 10, wherein presenting further includes presenting multiple other third-party services to the principal, each third-party service previously identified by the principal when the principal initially established an account with the method, where the principal selects the third-party service.

13. The method of claim 10, wherein acquiring further includes passing a federation token request to the principal and instructing the principal to authenticate to the third-party service and provide the federation token request to the third-party service to complete the processing of the reset password action.

14. The method of claim 13, wherein passing further includes providing a link to the principal that directs the principal to the third-party service, the link including the federation token request.

15. The method of claim 10, wherein acquiring further includes redirecting a browser of the principal to the third-party service with the federation token request for the principal to authenticate to the third-party service and cause the third-party service to generate a federated token that the method uses to reset an original password of the principal and to complete the reset password action on behalf of the principal.

16. The method of claim 10 further comprising:
receiving and authenticating a federated token from the third-party service; and
permitting the principal to log into the method via a reset password by completing the reset password action in response to the received and authenticated federated token acquired from the third-party service.

17. A multi-processor implemented system, comprising:
a client configured to execute a browser on one or more processors of the client at the direction of a principal;
a first server configured to execute a first service on one or more processors of the first server; and
a second server configured to execute an identity service on one or more processors of the second server;
the principal is to interact with the browser to attempt to log into the first service over a network connection via the first server, the first service permits the principal to select the identity service when the principal attempts to reset an original credential used to authenticate with the first service, the principal via the browser separately authenticates to the identity service via the second server and causes the identity service to communicate a federated token to the first service via the first server, the first service then permits the principal to change to a new authentication credential for authenticating and accessing the first service.

18. The system of claim 17, wherein the first service is to present different identity services for the principal to use and the principal selects the identity service.

19. The system of claim 17, wherein the federated token includes the new authentication credential that the principal wants to use when the first service receives the federated token and when the principal re-logs into the first service and presents the new authentication credential the principal is granted access to the first service.

20. The system of claim 19, wherein the first service requests that the principal create a different authentication credential once the principal is authenticated with the new authentication credential for access, the different authentication credential used on subsequent log in made by the principal to the first service.
